(19) United States
(12) Patent Application Publication
(10) Pub. No.: US 2021/0144712 A1
(43) Pub. Date: May 13, 2021

(54) METHOD AND APPARATUS FOR REPORTING BUFFER STATUS REPORT

(71) Applicant: BEIJING XIAOMI MOBILE SOFTWARE CO., LTD., BEIJING (CN)

(72) Inventor: Xiaowei JIANG, Beijing (CN)

(73) Assignee: BEIJING XIAOMI MOBILE SOFTWARE CO., LTD., BEIJING (CN)

(21) Appl. No.: 16/618,338

(22) PCT Filed: Jun. 19, 2017
(86) PCT No.: PCT/CN2017/088982

§ 371 Date: Nov. 30, 2019

(51) Int. Cl. H04W 72/04; H04W 72/10

(52) U.S. Cl. CPC H04W 72/0486; H04W 72/10

(57) ABSTRACT

A method for reporting a Buffer Status Report (BSR) includes: whether a trigger condition of triggering to report a target BSR again is currently satisfied is determined after the target BSR is reported to a base station; and the target BSR is reported to the base station again if the trigger condition is satisfied. A terminal can determine whether the trigger condition of triggering to report the target BSR again is currently satisfied after reporting the target BSR to the base station, and report the target BSR to the base station again if the trigger condition is satisfied. Therefore, the base station can allocate uplink resources to the terminal in time according to the target BSR, ensuring a transmission speed and quality of uplink data for the terminal.

### TECHNICAL FIELD

The present disclosure relates to the field of communication technology, and in particular to a method and an apparatus for reporting a buffer status report.

### BACKGROUND

In the related art, a terminal can report its own buffer status to a network side through a Buffer Status Report (BSR), so that a base station can allocate uplink resources to the terminal. In a manner, the terminal reports a periodic BSR to the base station according to a preset period. A regular BSR may also be reported in another manner, for example, in a trigger manner. The trigger manner is described below.

In a first case, an uplink data buffer of the terminal is empty and there is new data to be sent arriving.

In a second case, there is data to be sent with a high priority arriving currently.

It can be seen that if history data to be sent exists in a logical channel group and new data to be sent continuously arrives, the terminal may also report a buffer status again through a periodic BSR after sending a regular BSR. However, if the preset period of the periodic BSR is too short, the terminal will report the BSR more frequently, thereby resulting in an excessive overhead of the terminal. If the preset period is too long, the base station cannot acquire a BSR situation of the terminal in time, and thus cannot allocate uplink resources to the terminal in time.

### SUMMARY

To overcome problems existing in the related art, examples of the present disclosure provides a method and an apparatus for reporting a BSR.

According to a first aspect of the examples of the present disclosure, a method of reporting a BSR is provided. The method is applied to a terminal, and the method includes:

determining whether a trigger condition of triggering to report a target BSR again is currently satisfied after reporting the target BSR to a base station; and

reporting the target BSR to the base station again when the trigger condition is satisfied.

Optionally, the trigger condition includes any of the followings:

when first history data to be sent exists in a first logical channel, a logical channel group or the terminal, there is first new data to be sent arriving at the first logical channel, the logical channel group or the terminal, and a data volume of the first new data reaches a first preset value;

second new data arrives at the first logical channel, the logical channel group or the terminal, and an arrival time length of the second new data reaches a preset time length;

second history data to be sent exists in the first logical channel, the logical channel group or the terminal, and there is third new data to be sent arriving at the first logical channel, the logical channel group or the terminal, where a data volume of the second history data to be sent is smaller than a second preset value; and

a buffer corresponding to a second logical channel is empty and there is fourth new data to be sent arriving at the second logical channel, where the second logical channel is a logical channel with a priority lower than that of a target logical channel, and the target logical channel is a logical channel currently having a buffer for data transmission.

Optionally, the first logical channel is any logical channel or a logical channel with the highest priority among all logical channels currently having data to be sent; and

the logical channel group is any logical channel group or a logical channel group including the logical channel with the highest priority among all logical channels currently having the data to be sent.

Optionally, the trigger condition further includes that:

an arrival time length of the first new data reaching the preset time length; or

an arrival time length of the third new data reaching the preset time length.

Optionally, the trigger condition includes:

detecting that a quality of service flow is re-mapped from a first data radio bearer to a second data radio bearer in a service data adaptation protocol layer,

where the first data radio bearer and the second data radio bearer respectively correspond to different logical channel groups.

Optionally, the trigger condition further includes that:

data of the quality of service flow being buffered in the service data adaptation protocol layer and not sent to a packet data convergence protocol layer.

Optionally, prior to determining whether the trigger condition of triggering to report the target BSR again is currently satisfied, the method further includes:

receiving the first preset value, the preset time length and the second preset value that are sent through a radio resource control message and configured for the terminal by the base station.

Optionally, the target BSR includes a regular BSR or a padding BSR.

According to a second aspect of an example of the present disclosure, an apparatus for reporting a BSR is provided. The apparatus is applied to a terminal, and the apparatus includes:

a determining module configured to determine whether a trigger condition of triggering to report a target BSR again is currently satisfied after reporting the target BSR to a base station; and

a reporting module configured to report the target BSR to the base station again when the trigger condition is satisfied.

Optionally, the trigger condition includes any of the followings:

when first history data to be sent exists in a first logical channel, a logical channel group or the terminal, there is first new data to be sent arriving at the first logical channel, the logical channel group or the terminal, and a data volume of the first new data reaches a first preset value;

second new data arrives at the first logical channel, the logical channel group or the terminal, and an arrival time length of the second new data reaches a preset time length;

second history data to be sent exists in the first logical channel, the logical channel group or the terminal, and there is third new data to be sent arriving at the first logical channel, the logical channel group or the terminal, where a data volume of the second history data to be sent is smaller than a second preset value; and

a buffer corresponding to a second logical channel is empty and there is fourth new data to be sent arriving at the second logical channel, where the second logical channel is a logical channel with a priority lower than that of a target logical channel, and the target logical channel is a logical channel currently having a buffer for data transmission.

Optionally, the first logical channel is any logical channel or a logical channel with the highest priority among all logical channels currently having data to be sent;

the logical channel group is any logical channel group or a logical channel group including the logical channel with the highest priority among all logical channels currently having the data to be sent.

Optionally, the trigger condition further includes that:

an arrival time length of the first new data reaching the preset time length; or

an arrival time length of the third new data reaching the preset time length.

Optionally, the trigger condition includes:

detecting that a quality of service flow is re-mapped from a first data radio bearer to a second data radio bearer in a service data adaptation protocol layer,

where the first data radio bearer and the second data radio bearer respectively correspond to different logical channel groups.

Optionally, the trigger condition further includes that:

data of the quality of service flow being buffered in the service data adaptation protocol layer and not sent to a packet data convergence protocol layer.

Optionally, the apparatus further includes:

a receiving module configured to receive the first preset value, the preset time length and the second preset value that are sent through a radio resource control message and configured for the terminal by the base station.

Optionally, the target BSR includes a regular BSR or a padding BSR.

According to a third aspect of an example of the present disclosure, a computer-readable storage medium storing a computer program is provided. The computer program is used to perform the above method of reporting a BSR according to the first aspect.

According to a fourth aspect of an example of the present disclosure, an apparatus for reporting a BSR is provided. The apparatus is applied to a terminal, and the apparatus includes:

a processor, and

a memory for storing instructions executable by the processor,

where the processor is configured to:

determine whether a trigger condition of triggering to report a target BSR again is currently satisfied after reporting the target BSR to a base station; and

report the target BSR to the base station again when the trigger condition is satisfied.

The technical solution according to the examples of the present disclosure may include the following beneficial effects.

In an example of the present disclosure, the terminal can determine whether the trigger condition of triggering to report the target BSR again is currently satisfied after reporting the target BSR to the base station, and report the target BSR to the base station again when the trigger condition is satisfied. Therefore, the base station can allocate uplink resources to the terminal in time according to the target BSR, ensuring a transmission speed and quality of uplink data for the terminal.

In an example of the present disclosure, optionally, when the first history data to be sent exists in the first logical channel, the logical channel group or the terminal, if there is the first new data to be sent arriving and the data volume of the first new data reaches the first preset value, it is determined that the trigger condition of triggering to report the target BSR again is satisfied. In the example of the present disclosure, when the data volume of the first new data reaches the first preset value, it indicates that more new data to be sent currently arrives. In this case, the target BSR may be reported to the base station again, so that the base station allocates uplink resources to the terminal in time.

In an example of the present disclosure, when there is the second new data arriving at the first logical channel, the logical channel group or the terminal and the arrival time length of the second new data reaches the preset time length, it is determined that the trigger condition of triggering to report the target BSR again is satisfied. When the arrival time length of the arriving second new data reaches the preset time length, it indicates that the second new data arrived for a long time. Thus, the target BSR may be reported to the base station again, so that the base station allocates uplink resources to the terminal in time.

In an example of the present disclosure, it may also be determined that the trigger condition is satisfied when the second history data to be sent exists in the first logical channel, the logical channel group or the terminal and there is the third new data to be sent arriving, where the data volume of the second history data to be sent is smaller than the second preset value. In an example of the present disclosure, it may be determined that the trigger condition of triggering to report the target BSR again is satisfied when there is less second history data to be sent. Therefore, the target BST is reported to the base station for rapidly sending the uplink data from the terminal side.

In an example of the present disclosure, optionally, it may also be determined that the trigger condition is satisfied when the buffer corresponding to the second logical channel is empty and there is fourth new data to be sent arriving. Since the priority of the second logical channel is low, the reporting of the BSR cannot be triggered at this time according to the related art. However, in the example of the present disclosure, the target BSR may be reported again to ensure the transmission speed and quality of the uplink data for the terminal.

In an example of the present disclosure, optionally, the first logical channel is a logical channel with the highest priority among all logical channels currently having data to be sent, and the logical channel group is a logical channel group including the first logical channel. That is, when there is the first new data arriving at the logical channel with the highest priority or the logical channel group including the logical channel with the highest priority and the data volume of the first new data reaches the first preset value, it is determined that the trigger condition is satisfied. Or when there is the second new data arriving and the arrival time length of the second new data reaches the preset time length, it is determined that the trigger condition is satisfied. Or when the second history data to be sent exists and there is the third new data arriving, where the data volume of the second history data to be sent is smaller than the second preset value, it is determined that the trigger condition is satisfied. When it is determined that the trigger condition is satisfied, the target BSR is reported to the base station again. Therefore, the overhead of the BSR is saved while the transmission speed and quality of the uplink data for the terminal are ensured.

In an example of the present disclosure, optionally, the first history data to be sent exists in the first logical channel, the logical channel group or the terminal, and there is the first new data to be sent arriving, where the data volume of the first new data reaches the first preset value and the arrival time length of the first new data reaches the preset time length at the same time. At this time, it is determined that the trigger condition is satisfied. Alternatively, the second history data to be sent exists in the first logical channel, the logical channel group or the terminal, and there is the third new data arriving, where the data volume of the second history data to be sent is smaller than the second preset value and the arrival time length of the third new data reaches the preset time length. At this time, it is determined that the trigger condition is satisfied. Thus, the overhead of the BSR is further saved.

In an example of the present disclosure, the trigger condition may further include detecting that the quality of service flow is re-mapped from the first data radio bearer to the second data radio bearer in the service data adaptation protocol layer, where the first data radio bearer and the second data radio bearer correspond to different logical channel groups respectively. After the quality of service flow is re-mapped, a buffer situation of the terminal is changed. Correspondingly, the base station is required to re-adjust the uplink resources. Therefore, the terminal may report the target BSR to the base station again. Optionally, if the data of the quality of service flow is buffered in the service data adaptation protocol layer and is not sent to the packet data convergence protocol layer, it is also required to report the target BSR to the base station again to ensure the transmission speed and quality of the uplink data of the terminal.

In an example of the present disclosure, the base station may configure the first preset value, the preset time length and the second preset value for the terminal. Further, the base station may send the first preset value, the preset time length and the second preset value to the terminal through a radio resource control message. Subsequently, the terminal may determine whether the trigger condition of triggering to report the target BSR again is currently satisfied according to the first preset value, the preset time length and the second preset value, which is high in availability.

It is to be understood that the above general descriptions and the below detailed descriptions are merely exemplary and explanatory, and are not intended to limit the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a flowchart illustrating a method of reporting a buffer status report according to an example.

FIG. 2 is a flowchart illustrating another method of reporting a buffer status report according to another example.

FIG. 3 is a flowchart illustrating another method of reporting a buffer status report according to still another example.

FIG. 4 is a block diagram illustrating an apparatus for reporting a buffer status report according to an example.

FIG. 5 is a block diagram illustrating another apparatus for reporting a buffer status report according to another example.

FIG. 6 is a schematic diagram illustrating a structure of an apparatus for reporting a buffer status report according to an example of the present disclosure.

### DETAILED DESCRIPTION

Examples will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

The terms used in the present disclosure are for the purpose of describing particular examples only, and are not intended to limit the present disclosure. Terms determined by “a”, “the” and “said” in their singular forms in the present disclosure and the appended claims are also intended to include plurality, unless clearly indicated otherwise in the context. It should also be understood that the term “and/or” as used herein refers to and includes any and all possible combinations of one or more of the associated listed items.

It is to be understood that, although terms “first,” “second,” “third,” and the like may be used in the present disclosure to describe various information, such information should not be limited to these terms. These terms are only used to distinguish one category of information from another. For example, without departing from the scope of the present disclosure, first information may be referred as second information; and similarly, second information may also be referred as first information. Depending on the context, the word “if” as used herein may be interpreted as “when” or “upon” or “in response to determining”.

A method of reporting a Buffer Status Report (BSR) is provided according to examples of the present disclosure. The method may be applied to a terminal, and the method includes the following steps.

At step 101, whether a trigger condition of triggering to report a target BSR again is currently satisfied is determined after the target BSR is reported to a base station.

At step 102, the target BSR is reported to the base station again when the trigger condition is satisfied.

In the example, the terminal can determine whether the trigger condition of triggering to report the target BSR again is currently satisfied after reporting the target BSR to the base station, and report the target BSR to the base station again when the trigger condition is satisfied. Therefore, the base station can allocate uplink resources to the terminal in time according to the target BSR, ensuring a transmission speed and quality of uplink data for the terminal.

In an example of the present disclosure, for step 101, the target BSR may be a regular BSR or a padding BSR.

In the related art, the terminal may report a regular BSR to the base station when an uplink buffer is empty and there is new data to be sent arriving. That is, when all logical channels in all logical channel groups have no to-be-sent uplink data, if any logical channel belonging to any logical channel group has data to be sent, the terminal can report the regular BSR. For example, when sending uplink data to the base station for the first time, the terminal can trigger a process of sending the regular BSR to the base station.

Alternatively, when there is data to be sent with a high priority arriving currently, the terminal reports a regular BSR to the base station. That is, if the terminal already sends a BSR and is waiting for an uplink scheduling grant sent by the base station, at this time, data with a higher priority is to be sent, the terminal will report the regular BSR to the base station. A priority of a logical channel to which the data with the higher priority belongs is higher than a priority of a logical channel in any logical channel group.

The padding BSR refers to a BSR which is sent by use of padding bits when the base station allocates many uplink resources for the uplink data sent this time and the padding bits are not required for data transmission.

After the terminal reports the target BSR to the base station, the base station can allocate uplink resources to the terminal according to the target BSR in the related art, and the terminal can send the uplink data with the uplink resources after obtaining the uplink resources.

At this time, the terminal can detect whether the trigger condition of triggering to report the target BSR again is currently satisfied.

Concepts involved in the examples of the present disclosure will be firstly described below.

In an example of the present disclosure, the first logical channel may be any logical channel. Alternatively, to save overhead for the BSR, the first logical channel may be defined as a logical channel with the highest priority among all logical channels currently having data to be sent, that is, the logical channel with the highest priority.

The second logical channel is a logical channel with a priority lower than that of a target logical channel. That is, the second logical channel is a logical channel with a lower priority. The target logical channel is a logical channel currently having a buffer for data transmission.

In examples of the present disclosure, a logical channel group may be any logical channel group including a plurality of logical channels. Alternatively, to save overhead for the BSR, the logical channel group may be defined as a logical channel group including the logical channel with the highest priority, that is, a logical channel group including a logical channel with the highest priority among all logical channels currently having data to be sent.

History data to be sent may be distinguished according to an order of queuing time. History data to be sent with an early queuing time is taken as first history data to be sent, and history data to be sent with a late queuing time is taken as second history data to be sent, and the like.

New data to be sent may also be distinguished according to an order of arrival time. Data with the earliest arrival time is first new data, and next is second new data, third new data, fourth new data, and the like.

In examples of the present disclosure, based on the above definitions, optionally, the trigger condition includes any of the followings.

In a first case, when first history data to be sent exists in the first logical channel, the logical channel group or the terminal, there is first new data to be sent arriving at the first logical channel, the logical channel group or the terminal, where a data volume of the first new data reaches a first preset value.

After the target BSR is reported, if the first history data to be sent still exists in the first logical channel, the logical channel group or the terminal and there is the first new data to be sent arriving, where the data volume of the first new data reaches the first preset value, it indicates that more new data currently arrives. If the uplink resources allocated by the base station are acquired only by waiting for reporting a periodic BSR, there will be a large quantity of newly arriving data being in a to-be-sent state at the terminal side, which affects the transmission speed and quality of the uplink data. Therefore, in an example of the present disclosure, it is determined that the trigger condition of triggering to report the target BSR again is satisfied at this time.

In an example of the present disclosure, it is to be noted that the first logical channel, the logical channel group and the terminal may perform statistics according to different buffer data volumes. That is, the first preset values corresponding to the first logical channel, the logical channel group and the terminal may be different values. For example, when the data volume of the first new data reaches first preset value A₁, the first logical channel determines that the trigger condition is satisfied. When the data volume of the first data reaches first preset value A₂, the logical channel group determines that the trigger condition is satisfied. When the data volume of the first new data reaches first preset value A₃, the terminal determines that the trigger condition is satisfied. And A₁<A₂<A₃.

If the first history data to be sent exists in each logical channel or each logical channel group and there is the first new data to be sent arriving at each logical channel or each logical channel group, where the data volume of the first new data reaches the first preset value, it is determined that the trigger condition is satisfied and the target BSR is reported to the base station, thereby causing large overhead for the BSR.

In an example of the present disclosure, optionally, when the first logical channel is the logical channel with the highest priority among all logical channels currently having data to be sent, that is, when the first logical channel is the logical channel with the highest priority, if the first history data to be sent exists in the first logical channel and there is the first new data to be sent arriving, where the data volume of the first new data reaches the first preset value, it may be determined that the trigger condition is satisfied, thereby saving the overhead for the BSR.

Similarly, when the logical channel group includes the first logical channel, that is, when the logical channel group includes the logical channel with the highest priority, if the first history data to be sent exists in the logical channel group and there is the first new data to be sent arriving, where the data volume of the first new data reaches the first preset value, it is determined that the trigger condition is satisfied. In this way, the overhead for the BSR is also saved.

In addition, in this case, when an arrival time length of the first new data in the first logical channel, the logical channel group or the terminal reaches a preset time length, it may also be determined that the trigger condition is satisfied. That is, when the first history data to be sent exists in the first logical channel, the logical channel group or the terminal and there is the first new data to be sent arriving, where the data volume of the arriving first new data is large and the arrival time length of the arriving first new data is long, it may be determined that the trigger condition is satisfied. At this time, it is determined that the trigger condition of triggering to report the target BSR to the base station again is satisfied, further saving the overhead for the BSR.

In a second case, second new data arrives at the first logical channel, the logical channel group or the terminal, and an arrival time length of the second new data reaches a preset time length.

After the target BSR is reported, if there is second new data arriving again at the first logical channel, the logical channel group or the terminal and the arrival time length of the second new data reaches the preset time length, it indicates that the second new data arrived for a long time. If the uplink resources allocated by the base station are acquired only by waiting for reporting a periodic BSR, the second new data at the terminal side will wait longer, which affects the transmission speed and quality of the uplink data. Therefore, in an example of the present disclosure, it is determined that the trigger condition of triggering to report the target BSR again is satisfied at this time.

Optionally, the preset time lengths corresponding to the first logical channel, the logical channel group and the terminal may be different time lengths. For example, the first logical channel, the logical channel group and the terminal determine that the trigger condition is satisfied when the arrival time length of the second new data reaches preset time lengths T₁, T₂ and T₃ respectively. A value of T₃ may be the largest, and a value of T₁ may be the smallest.

In addition, in this case, to save the overhead for the BSR, when the first logical channel is the logical channel with the highest priority or the logical channel group includes the logical channel with the highest priority, if there is the second new data to be sent arriving at the first logical channel or the logical channel group and the arrival time length of the second new data reaches the preset time length, it may be determined that the trigger condition is satisfied.

In a third case, second history data to be sent exists in the first logical channel, the logical channel group or the terminal, and there is the third new data to be sent arriving at the first logical channel, the logical channel group or the terminal, where a data volume of the second history data to be sent is smaller than a second preset value.

After the target BSR is reported, when the second history data to be sent exists at the first logical channel, the logical channel group or the terminal and there is the third new data to be sent arriving, if the data volume of the second history data to be sent is smaller than the second preset value and the uplink resources allocated by the base station are acquired only by waiting for reporting a periodic BSR according to the related art, the transmission of the second history data to be sent cannot be rapidly completed. Therefore, in an example of the present disclosure, it is determined that the trigger condition of triggering to report the target BSR again is satisfied at this time.

Optionally, the second preset values corresponding to the first logical channel, the logical channel group and the terminal may also be different values. For example, the first logical channel, the logical channel group and the terminal may determine that the trigger condition is satisfied when the data volumes of the existing second history data to be sent are second preset values B₁, B₂ and B₃ respectively. A value of B₃ may be the largest, and a value of B₁ may be the smallest.

In addition, in this case, to save the overhead for the BSR, when the first logical channel is the logical channel with the highest priority or the logical channel group includes the logical channel with the highest priority, if the second history data to be sent exists in the first logical channel or the logical channel group and there is the third new data to be sent arriving at the first logical channel or the logical channel group, where the data volume of the second history data to be sent is smaller than the second preset value, it may be determined that the trigger condition is satisfied.

Optionally, in this case, it may also be determined that the trigger condition is satisfied when the arrival time length of the third new data in the first logical channel, the logical channel group or the terminal reaches a preset time length. That is, it may be determined that the trigger condition is satisfied when the second history data to be sent exists in the first logical channel, the logical channel group or the terminal and there is third new data arriving at the first logical channel, the logical channel group or the terminal, where the data volume of the second history data to be sent is small and the arrival time length of the arriving third new data is long. In this case, it is required to report the target BSR to the base station again. Therefore, the overhead for the BSR is further saved.

In a fourth case, a buffer corresponding to the second logical channel is empty and there is fourth new data to be sent arriving at the second logical channel. The second logical channel is a logical channel with a priority lower than that of a target logical channel, and the target logical channel is a logical channel currently having a buffer for data transmission.

In this case, the second logical channel is the logical channel with the priority lower than the priority of the target logical channel, that is, the priority of the second logical channel is lower. After the second logical channel reports the target BSR, if the corresponding buffer is empty and there is the fourth new data to be sent arriving, reporting a regular BSR cannot be triggered according to the related art. Thus, the corresponding uplink resources are acquired only by waiting for reporting the periodic BSR. In an example of the present disclosure, to improve the transmission speed and quality of the uplink data, it may be determined that the trigger condition of triggering to report the target BSR again is satisfied at this time.

In a fifth case, it is detected that a Quality of Service (QoS) flow is re-mapped from a first Data Radio Bearer (DRB) to a second DRB in a Service Data Adaptation Protocol (SDAP) layer, where the first DRB and the second DRB correspond to different logical channel groups.

According to a current link requirement and the like, the base station may re-map a particular QoS flow from the first DRB to the second DRB in the SDAP layer through a Radio Resource Control (RRC) message. If the first DRB and the second DRB correspond to different logical channel groups, the buffer situation of the terminal is changed. Correspondingly, the base station is required to re-adjust the uplink resources. Therefore, in an example of the present disclosure, it may be determined that the trigger condition of triggering to report the target BSR again is satisfied at this time.

Optionally, in this case, when data of the QoS flow is buffered in the SDAP layer and is not sent to a lower Packet Data Convergence Protocol (PDCP) layer, it is determined that the trigger condition is satisfied, thereby saving the overhead for the BSR.

In examples of the present disclosure, when it is determined any of the above cases is satisfied, it may be determined that the trigger condition of triggering to report the target BSR again is satisfied. Then, step 102 is performed.

For step 102, the terminal can report the target BSR to the base station again according to the related art. The target BSR may be a regular BSR or a padding BSR.

When the target BSR is a regular BSR, a Media Access Control (MAC) Control

Element (CE) of the regular BSR may be included in a MAC Protocol Data Unit (PDU) sent to the base station, thereby achieving a purpose of reporting the regular BSR to the base station.

When the target BSR is a padding BSR, after the terminal receives the uplink resources allocated by the base station, the padding BSR may be included in a location corresponding to the padding bits not used for data transmission, and a MAC CE of the padding BSR may be included in the MAC PDU, achieving a purpose of reporting the padding BSR to the base station.

After receiving the target BSR, the base station will allocate the uplink resources to the terminal in time according to the related art, so that the terminal sends the uplink data.

In an example of the present disclosure, after the target BSR is reported to the base station again when the trigger condition is satisfied, the terminal can continue to detect whether the trigger condition is still satisfied, and report the target BSR to the base station again when determining that the trigger condition is satisfied again. Therefore, the base station can allocate the uplink resources to the terminal in time according to the target BSR, ensuring the transmission speed and quality of the uplink data of the terminal.

FIG. 2 illustrates another method of reporting a buffer status report based on the example shown in FIG. 1. In an example, as shown in FIG. 2, before step 101 is performed, the method of reporting a buffer status report further includes the following steps.

At step 100, a first preset value, a preset time length and a second preset value that are sent by a base station through an RRC message and configured for a terminal are received.

At this step, the base station can pre-send the terminal the first preset value, the preset time length and the second preset value that are configured for the terminal through the RRC message. After receiving the first preset value, the preset time length and the second preset value, the terminal may take the first preset value, the preset time length and the second preset value configured for the terminal as several factors for determining whether the trigger condition is satisfied. Further, when determining the trigger condition is satisfied, the terminal reports the target BSR to the base station again.

In the example, the base station may configure a corresponding first preset value, a corresponding preset time length and a corresponding second preset value for the terminal, so that the terminal determines whether the trigger condition is satisfied according to the configuration from the base station, ensuring the transmission speed and quality of the uplink data of the terminal.

FIG. 3 illustrates another method of reporting a buffer status report according to an example. As shown in FIG. 3, the method includes the following steps.

At step 201, a base station sends a first preset value, a preset time length and a second preset value configured for a terminal to the terminal through an RRC message. At step 202, the terminal reports a target BSR to the base station.

At step 203, the base station allocates uplink resources to the terminal according to the target BSR.

At step 204, the terminal sends uplink data to the base station with the uplink resources allocated by the base station.

At step 205, when determining that a trigger condition of triggering to report the target BSR again is currently satisfied, the terminal reports the target BSR to the base station again, and then steps 203-204 are performed.

The trigger condition may be determined according to one of the first preset value, the preset time length and the second preset value configured by the base station, or may also be determined according to whether a QoS flow is re-mapped.

After the terminal receives the first preset value from the base station through step 201, when first history data to be sent exists in first logical channel, logical channel group or the terminal and there is first new data to be sent arriving at the first logical channel, the logical channel group or the terminal, the terminal may determine whether a data volume of the first new data reaches the first preset value, and determine that the trigger condition is satisfied when the data volume of the first new data reaches the first preset value.

After the terminal receives the preset time length from the base station through step 201, if there is second new data to be sent arriving at the first logical channel, the logical channel group or the terminal, the terminal may also determine whether an arrival time length of the second new data reaches the prese time length, and determine that the trigger condition is satisfied when the arrival time length of the second new data reaches the prese time length.

After the terminal receives the second preset value from the base station through step 201, when second history data to be sent exists in the first logical channel, the logical channel group or the terminal and there is third new data to be sent arriving at the first logical channel, the logical channel group or the terminal, the terminal may also determine whether a data volume of the second history data to be sent is smaller than the second preset value, and determine that the trigger condition is satisfied when the data volume of the second history data to be sent is smaller than the second preset value.

Alternatively, the terminal may also detect whether the QoS flow is re-mapped in a SDAP layer. The terminal may determine that the trigger condition is satisfied if the QoS flow is re-mapped from a first DRB to a second DRB in the SDAP layer, where the first DRB and the second DRB correspond to different logical channel groups.

Further, after the terminal detects that the QoS flow is re-mapped in the SDAP layer, if data of the QoS flow is buffered in the SDAP layer and is not sent to a PDCP layer, the terminal may also determine that the trigger condition is satisfied at this time.

In the example, the base station configures the first preset value, the preset time length and the second preset value, and the like for the terminal, and sends the first preset value, the preset time length and the second preset value, and the like to the terminal through the RRC message. After the terminal reports the target BSR to the base station, the terminal reports the target BSR to the base station again if determining that the trigger condition is satisfied. In this way, the transmission speed and quality of the uplink data of the terminal is ensured.

Corresponding to the foregoing examples of methods of implementing application functions, the present disclosure further provides examples of apparatuses and corresponding terminals for implementing application functions.

FIG. 4 is a block diagram illustrating an apparatus for reporting a BSR according to an example. The apparatus is applied to a terminal, and the apparatus includes:

a determining module 310, configured to determine whether a trigger condition of triggering to report a target BSR again is currently satisfied after reporting the target BSR to a base station; and

a reporting module 320, configured to report the target BSR to the base station again when the trigger condition is satisfied.

Optionally, the trigger condition includes any one of the followings:

when first history data to be sent exists in a first logical channel, a logical channel group or the terminal, there is first new data to be sent arriving at the first logical channel, the logical channel group or the terminal, and a data volume of the first new data reaches a first preset value;

second new data arrives at the first logical channel, the logical channel group or the terminal, and an arrival time length of the second new data reaches a preset time length;

second history data to be sent exists in the first logical channel, the logical channel group or the terminal, and there is third new data to be sent arriving at the first logical channel, the logical channel group or the terminal, where a data volume of the second history data to be sent is smaller than a second preset value; and

a buffer corresponding to a second logical channel is empty and there is fourth new data to be sent arriving at the second logical channel, where the second logical channel is a logical channel with a priority lower than that of a target logical channel, and the target logical channel is a logical channel currently having a buffer for data transmission.

Optionally, the first logical channel is any logical channel or a logical channel with the highest priority among all logical channels currently having data to be sent.

The logical channel group is any logical channel group or a logical channel group including the logical channel with the highest priority among all logical channels currently having the data to be sent.

Optionally, the trigger condition further includes:

an arrival time length of the first new data reaching the preset time length; or

an arrival time length of the third new data reaching the preset time length.

Optionally, the trigger condition includes:

detecting that a quality of service flow is re-mapped from a first data radio bearer to a second data radio bearer in a service data adaptation protocol layer,

where the first data radio bearer and the second data radio bearer respectively correspond to different logical channel groups.

Optionally, the trigger condition further includes:

data of the quality of service flow being buffered in the service data adaptation protocol layer and not sent to a packet data convergence protocol layer.

FIG. 5 is a block diagram illustrating another apparatus for reporting a BSR based on the example shown in FIG. 4. As shown in FIG. 5, the apparatus further includes:

a receiving module 330, configured to receive the first preset value, the preset time length and the second preset value that are sent through a radio resource control message and configured for the terminal by the base station.

Optionally, the target BSR includes a regular BSR or a padding BSR.

Since the apparatus examples substantially correspond to the method examples, a reference may be made to part of the descriptions of the method examples for the related part. The apparatus examples described above are merely illustrative, where the units described as separate members may be or not be physically separated, and the members displayed as units may be or not be physical units, e.g., may be located in one place, or may be distributed to a plurality of network units. Part or all of the modules may be selected according to actual requirements to implement the objectives of the solutions in the examples. Those of ordinary skill in the art may understand and carry out them without creative work.

Correspondingly, the present disclosure further provides a computer-readable storage medium storing a computer program. The computer program is used to perform any method of reporting a BSR as described above.

Correspondingly, the present disclosure further provides an apparatus for reporting a buffer status report. The apparatus is applied to a terminal, and the apparatus includes:

a processor; and

a memory for storing instructions executable by the processor.

The processor is configured to:

determine whether a trigger condition of triggering to report a target BSR again is currently satisfied after reporting the target BSR to a base station; and

report the target BSR to the base station again when the trigger condition is satisfied.

FIG. 6 is a schematic diagram illustrating a structure of an apparatus for reporting a

BSR according to an example. As shown in FIG. 6, an apparatus 600 for reporting a BSR according to the example may be a terminal, such as a computer, a mobile phone, a digital broadcast terminal, a message transceiving device, a game console, a tablet device, a medical device, a fitness device, and a personal digital assistant.

As shown in FIG. 6, the apparatus 600 may include one or more of the following components: a processing component 601, a memory 602, a power component 603, a multimedia component 604, an audio component 605, an input/output (I/O) interface 606, a sensor component 607, and a communication component 608.

The processing component 601 usually controls the overall operation of the apparatus 600, such as operations associated with display, telephone calls, data communications, camera operations, and recording operations. The processing component 601 may include one or more processors 609 to execute instructions to perform all or part of the steps in the methods described above. Moreover, the processing component 601 may include one or more modules to facilitate interaction between the processing component 601 and other components. For example, the processing component 601 may include a multimedia module to facilitate interaction between the multimedia component 604 and the processing component 601.

The memory 602 is configured to store various types of data to support operation at the apparatus 600. Examples of these data include instructions for any application or method operating at the apparatus 600, contact data, phone book data, messages, pictures, videos, and the like. The memory 602 may be implemented by any type of volatile or non-volatile storage device or a combination thereof, such as a Static Random Access Memory (SRAM), an Electrically Erasable Programmable Read Only Memory (EEPROM), an Erasable Programmable Read Only Memory (EPROM), a Programmable Read Only Memory (PROM), a Read Only Memory (ROM), a magnetic memory, a flash memory, a disk or a compact disk.

The power component 603 supplies power to various components of the apparatus 600. The power component 603 may include a power management system, one or more power sources, and other components associated with power generated, managed, and distributed for the apparatus 600.

The multimedia component 604 includes a screen that provides an output interface between the apparatus 600 and a user. In some examples, the screen may include a liquid crystal display (LCD) and a touch panel (TP). If the screen includes a touch panel, the screen may be implemented as a touch screen to receive input signals from the user. The touch panel includes one or more touch sensors to sense touches, slides, and gestures on the touch panel. The touch sensor may not only sense the boundary of touch or slide actions but also detect the duration and pressure associated with touch or slide operations. In some examples, the multimedia component 604 includes a front camera and/or a rear camera. When the apparatus 600 is in an operation mode, such as a shooting mode or a video mode, the front camera and/or the rear camera may receive external multimedia data. Each of the front and rear cameras may be a fixed optical lens system or have a focal length and an optical zoom capability.

The audio component 605 is configured to output and/or input audio signals. For example, the audio component 605 includes a microphone (MIC) configured to receive an external audio signal when the apparatus 600 is in an operation mode, such as a call mode, a recording mode, and a voice recognition mode. The received audio signal may be further stored in the memory 602 or transmitted via the communication component 608. In some examples, the audio component 605 also includes a loudspeaker for outputting an audio signal.

The I/O interface 606 provides an interface between the processing component 601 and a peripheral interface module which may be a keyboard, a click wheel, a button, or the like. These buttons may include, but are not limited to a home button, a volume button, a start button, and a lock button.

The sensor component 607 includes one or more sensors for providing a status assessment in various aspects to the apparatus 600. For example, the sensor component 607 may detect an open/closed state of the apparatus 600, and the relative positioning of components, for example, the component is a display and a keypad of the apparatus 600. The sensor component 607 may also detect a change in position of the apparatus 600 or a component of the apparatus 600, the presence or absence of a user in contact with the apparatus 600, the orientation or acceleration/deceleration of the apparatus 600 and a change in temperature of the apparatus 600. The sensor component 607 may include a proximity sensor configured to detect the presence of nearby objects without any physical contact. The sensor component 607 may also include a light sensor, such as a CMOS or CCD image sensor, for use in imaging applications. In some examples, the sensor component 607 may also include an acceleration sensor, a gyro sensor, a magnetic sensor, a pressure sensor, or a temperature sensor.

The communication component 608 is configured to facilitate wired or wireless communication between the apparatus 600 and other devices. The apparatus 600 may access a wireless network based on a communication standard, such as Wi-Fi, 2G or 3G, or a combination thereof. In an example, the communication component 608 receives broadcast signals or broadcast associated information from an external broadcast management system via a broadcast channel. In an example, the communication component 608 also includes a Near Field Communication (NFC) module to facilitate short range communication. For example, the NFC module may be implemented based on a Radio Frequency IDentification (RFID) technology, an Infrared Data Association (IrDA) technology, an Ultra-Wide Band (UWB) technology, a Bluetooth (BT) technology, and other technologies.

In an example, the apparatus 600 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors or other electronic elements for performing the above methods.

In an example, there is also provided a non-transitory computer-readable storage medium including instructions, such as a memory 602 including instructions, where the instructions are executable by the processor 609 of the apparatus 600 to perform the method as described above. For example, the non-transitory computer readable storage medium may be a ROM, a Random-Access Memory (RAM), a CD-ROM, a magnetic tape, a floppy disk, and an optical data storage device.

When the instructions in the storage medium are executed by the processor, the apparatus 600 is caused to perform any method of reporting a BSR as described above.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the related art that are not disclosed in the present disclosure. The specification and examples are considered as exemplary only, with a true scope and spirit of the present disclosure being indicated by the following claims.

It is to be understood that the present disclosure is not limited to the precise structure described above and shown in the accompanying drawings, and that various modifications and changes may be made without departing from the scope thereof. The scope of the present disclosure is limited only by the appended claims.

1. A method of reporting a Buffer Status Report (BSR), the method being applied to a terminal, and comprising:
determining whether a trigger condition of triggering to report a target BSR again is currently satisfied after reporting the target BSR to a base station; and
reporting the target BSR to the base station again when the trigger condition is satisfied.

2. The method according to claim 1, wherein the trigger condition comprises any of the followings:
when first history data to be sent exists in a first logical channel, a logical channel group or the terminal, there is first new data to be sent arriving at the first logical channel, the logical channel group or the terminal, and a data volume of the first new data reaches a first preset value;
second new data arrives at the first logical channel, the logical channel group or the terminal, and an arrival time length of the second new data reaches a preset time length;
second history data to be sent exists in the first logical channel, the logical channel group or the terminal, and there is third new data to be sent arriving at the first logical channel, the logical channel group or the terminal, wherein a data volume of the second history data to be sent is smaller than a second preset value; and
a buffer corresponding to a second logical channel is empty and there is fourth new data to be sent arriving at the second logical channel, wherein the second logical channel is a logical channel with a priority lower than that of a target logical channel, and the target logical channel is a logical channel currently having a buffer for data transmission.

3. The method according to claim 2, wherein the first logical channel is any logical channel or a logical channel with the highest priority among all logical channels currently having data to be sent; and
the logical channel group is any logical channel group or a logical channel group comprising the logical channel with the highest priority among all logical channels currently having the data to be sent.

4. The method according to claim 2, wherein the trigger condition further comprises:
an arrival time length of the first new data reaching the preset time length; or
an arrival time length of the third new data reaching the preset time length.

5. The method according to claim 1, wherein the trigger condition comprises:
detecting that a quality of service flow is re-mapped from a first data radio bearer to a second data radio bearer in a service data adaptation protocol layer,
wherein the first data radio bearer and the second data radio bearer respectively correspond to different logical channel groups.

6. The method according to claim 5, wherein the trigger condition further comprises:
data of the quality of service flow being buffered in the service data adaptation protocol layer and not sent to a packet data convergence protocol layer.

7. The method according to claim 2, wherein prior to determining whether the trigger condition of triggering to report the target BSR again is currently satisfied, further comprising:
receiving the first preset value, the preset time length and the second preset value that are sent through a radio resource control message and configured for the terminal by the base station.

8. The method according to claim 1, wherein the target BSR comprises a regular BSR or a padding BSR.

9.-16. (canceled)

17. A non-transitory computer-readable storage medium storing a computer program that, when executed by a processor, causes the processor to:
determine whether a trigger condition of triggering to report a target BSR again is currently satisfied after reporting the target BSR to a base station; and
report the target BSR to the base station again when the trigger condition is satisfied.

18. An apparatus for reporting a BSR, the apparatus being applied to a terminal, and comprising:
a processor; and
a memory for storing instructions executable by the processor,
wherein the processor is configured to:
determine whether a trigger condition of triggering to report a target BSR again is currently satisfied after reporting the target BSR to a base station; and
report the target BSR to the base station again when the trigger condition is satisfied.

19. The method according to claim 3, wherein the trigger condition further comprises:
an arrival time length of the first new data reaching the preset time length; or
an arrival time length of the third new data reaching the preset time length.

20. The apparatus according to claim 18, wherein the trigger condition comprises any of the followings:
when first history data to be sent exists in a first logical channel, a logical channel group or the terminal, there is first new data to be sent arriving at the first logical channel, the logical channel group or the terminal, and a data volume of the first new data reaches a first preset value;
second new data arrives at the first logical channel, the logical channel group or the terminal, and an arrival time length of the second new data reaches a preset time length;
second history data to be sent exists in the first logical channel, the logical channel group or the terminal, and there is third new data to be sent arriving at the first logical channel, the logical channel group or the terminal, wherein a data volume of the second history data to be sent is smaller than a second preset value; and
a buffer corresponding to a second logical channel is empty and there is fourth new data to be sent arriving at the second logical channel, wherein the second logical channel is a logical channel with a priority lower than that of a target logical channel, and the target logical channel is a logical channel currently having a buffer for data transmission.

21. The apparatus according to claim 20, wherein the first logical channel is any logical channel or a logical channel with the highest priority among all logical channels currently having data to be sent; and
the logical channel group is any logical channel group or a logical channel group comprising the logical channel with the highest priority among all logical channels currently having the data to be sent.

22. The apparatus according to claim 20, wherein the trigger condition further comprises:
an arrival time length of the first new data reaching the preset time length; or
an arrival time length of the third new data reaching the preset time length.

23. The apparatus according to claim 21, wherein the trigger condition further comprises:
an arrival time length of the first new data reaching the preset time length; or
an arrival time length of the third new data reaching the preset time length.

24. The apparatus according to claim 18, wherein the trigger condition comprises:
detecting that a quality of service flow is re-mapped from a first data radio bearer to a second data radio bearer in a service data adaptation protocol layer,
wherein the first data radio bearer and the second data radio bearer respectively correspond to different logical channel groups.

25. The apparatus according to claim 24, wherein the trigger condition further comprises:
data of the quality of service flow being buffered in the service data adaptation protocol layer and not sent to a packet data convergence protocol layer.

26. The apparatus according to claim 20, wherein prior to determining whether the trigger condition of triggering to report the target BSR again is currently satisfied, the processor is further configured to:
receive the first preset value, the preset time length and the second preset value that are sent through a radio resource control message and configured for the terminal by the base station.

27. The apparatus according to claim 18, wherein the target BSR comprises a regular BSR or a padding BSR.
